(19) United States
(12) Patent Application Publication
(10) Pub. No.: US 2018/0134839 A1
(43) Pub. Date: May 17, 2018

(54) MONOMERIC AND OLIGOMERIC RESINS FOR ONE DROP FILL SEALANT APPLICATION

(71) Applicants: Henkel IP & Holding GmbH, Duesseldorf (DE); Henkel AG & Co. KGaA, Duesseldorf (DE)

(72) Inventors: Laxmisha M. Sridhar, Monmouth Junction, NJ (US); Baoshan Gao, Shanghai (CN); Jing Zhou, Shanghai (CN); Qin Li, Shanghai (CN); Wenhua Zhang, Farmington, CT (US); Shengian Kong, Hillsborough, NJ (US); John G. Woods, Farmington, CT (US); Anthony F. Jacobine, North Haverhill, NH (US)

(21) Appl. No.: 15/871,051

(22) Filed: Jan. 14, 2018

Related U.S. Application Data
(63) Continuation of application No. PCT/CN2015/083963, filed on Jul. 14, 2015.

(51) Int. Cl. C08G 59/40; C08G 59/02; C09J 171/12; C08K 5/3415

(52) U.S. Cl. CPC C08G 59/4014; C08G 59/02; G02F 1/13; C08K 5/3415; C09J 171/12

(57) ABSTRACT

The present invention relates to curable novel resins and prepolymers, methods of manufacture and compositions made therefrom. Particularly useful applications include one drop fill sealant used in liquid crystal assembly. In particular, the inventive resins and prepolymers and compositions are useful in the assembly of LCD panels.

### BACKGROUND

### Field

The present invention relates to monomers and oligomers useful as sealants and particularly as one drop fill sealants for liquid crystal applications. In particular, the present invention permits assembly of LCD panels without migration of the sealant resin into the liquid crystal or vice versa during LCD assembly and/or curing of the resin.

### BRIEF DESCRIPTION OF RELATED TECHNOLOGY

The one drop fill (“ODF”) process is becoming the mainstream process in the assembly of LCD panels in display applications, replacing the conventional vacuum injection technology to meet faster manufacturing process demands. In the ODF process, first, a sealant is dispensed on an electrode-equipped substrate to form a frame of a display element, and liquid crystals are dropped inside the depicted frame. In the next step of the assembly, another electrode equipped substrate is joined thereto under vacuum. Then, the sealant undergoes a curing process, either by a combination of UV and thermal or by thermal only process.

The ODF method has a few problems in that the sealant material in the uncured state comes into contact with the liquid crystal during the assembly process. This could cause reduction in electro-optical properties of the liquid crystal by resin migration into the liquid crystal or vice versa, or because of ionic impurities that may be present. Hence, design of resin systems for sealant material that show good liquid crystal resistance (less contamination) along with good adhesion and moisture barrier properties has remained a challenge.

### SUMMARY

The present invention relates to unique resins and ODF compositions made therefrom.

In one aspect of the invention there is included a resin having the structure I:

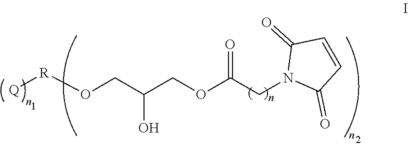

### Wherein:

Q may be selected from:

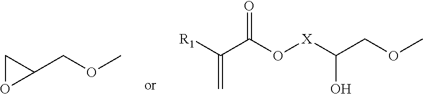

### Wherein:

R is a multivalent hydrocarbyl linker selected from linear or branched alkyls, linear or branched cycloalkyls, alkylenes, cycloalkylenes, bicycloalkylenes, tricycloalkylenes, linear or branched alkylenes, linear or branched cycloalkylenes, linear or branched alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene or heterocycloarylenes; the alkyls, cycloalkyls, alkylenes, cycloalkylenes, alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene and heterocycloarylenes can optionally contain O or S or hydroxyl group;
R₁ is methyl or H;

### X is CH₂,

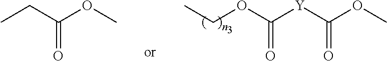

n, n₁, n₂, and n₃ are each independently 1-10; and
Y is arylene, alkylene, alkenylene, aralkylene, cycloalkylene, bicycloalkylene or tricycloalkylene.

In another aspect of the invention there is included a resin having the structure II:

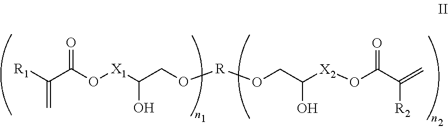

### Wherein:

R is a multivalent hydrocarbyl linker selected from linear or branched alkyls, linear or branched cycloalkyls, alkylenes, cycloalkylenes, bicycloalkylenes, tricycloalkylenes, linear or branched alkylenes, linear or branched cycloalkylenes, linear or branched alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene or heterocycloarylenes; the alkyls, cycloalkyls, alkylenes, cycloalkylenes, alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene and heterocycloarylenes can optionally contain O, S or hydroxyl group;
R₁ and R₂ are independently methyl or H;
n₁ and n₂ are each independently 1-10; and
X₁ and X₂ are independently selected from CH₂,

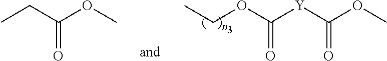

wherein n₃ is 1-10, and Y is arylene, alkylene, alkenylene, aralkylene, cycloalkylene, bicycloalkylene or tricycloalkylene.

In yet another aspect of the invention there is included a resin having the structure III:

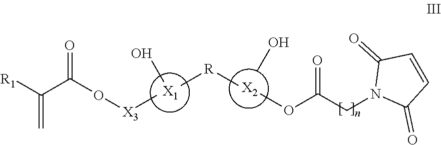

### Wherein:

X₁ and X₂ are 3-10 membered ring groups independently selected from functionalized or unfunctionalized alicyclic groups optionally having one or more heteroatoms;
n is 1-10;
R is a multivalent hydrocarbyl linker selected from linear or branched alkyls, linear or branched cycloalkyls, alkylenes, cycloalkylenes, bicycloalkylenes, tricycloalkylenes, linear or branched alkylenes, linear or branched cycloalkylenes, linear or branched alkenylenes, arylenes, aralkylenes, arylbicycloalkylenes, arylbicycloalkylenes, bicycloalkylarylenes, tricycloalkylarylenes, bisphenylenes, cycloalkylarylenes, heterocycloalkylene or heterocycloarylenes; the alkyls, cycloalkyls, alkylenes, cycloalkylenes, alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene and heterocycloarylenes can optionally contain O or S or hydroxyl group; and R is linked to the ring structures containing X₁ and X₂ at any position;
X₃ is a bond linking the methacrylate group to the ring X₁, or

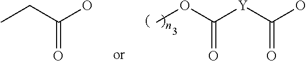

wherein n₃ is 1-10; and
Y is arylene, alkylene, alkenylene, aralkylene, cycloalkylene, bicycloalkylene or tricycloalkylene; with the proviso that hydroxyl group on X₁ ring is adjacent to the X₃ group containing (meth)acrylate, and hydroxyl group on the X₂ ring is adjacent to the maleimidoalkanoyl group, respectively.

In still another aspect of the invention there is included a resin having the structure IV:

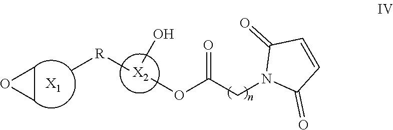

### Wherein:

X₁ and X₂ are 3-10 membered ring groups independently selected from functionalized or unfunctionalized alicyclic groups optionally having one or more heteroatoms;
R is a multivalent hydrocarbyl linker selected from linear or branched alkyls, linear or branched cycloalkyls, alkylenes, cycloalkylenes, bicycloalkylenes, tricycloalkylenes, linear or branched alkylenes, linear or branched cycloalkylenes, linear or branched alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene or heterocycloarylenes; the alkyls, cycloalkyls, alkylenes, cycloalkylenes, alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene and heterocycloarylenes can optionally contain O or S or hydroxyl group;
R may be linked to the ring structures X₁ and X₂ at any position, with the proviso that the hydroxyl group on X₂ ring is adjacent to the maleimidoalkanoyl group; and
n is 1-10.

In still another aspect of the invention there is included a resin having the structure V:

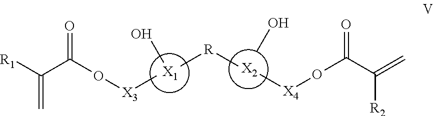

### Wherein:

X₁ and X₂ are 3-10 membered ring groups independently selected from functionalized or unfunctionalized alicyclic groups optionally having one or more heteroatoms;
R is a multivalent hydrocarbyl linker selected from linear or branched alkyls, linear or branched cycloalkyls, alkylenes, cycloalkylenes, bicycloalkylenes, tricycloalkylenes, linear or branched alkylenes, linear or branched cycloalkylenes, linear or branched alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene or heterocycloarylenes; the alkyls, cycloalkyls, alkylenes, cycloalkylenes, alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene and heterocycloarylenes can optionally contain O or S or hydroxyl group; R is linked to the ring structures X₁ and X₂ at any position;
X₃ and X₄ may be independently a bond linking the (meth)acrylate groups to the rings X₁ and X₂,

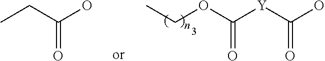

wherein n₃ is 1-10; and
Y is arylene, alkylene, alkenylene, aralkylene, cycloalkylene, bicycloalkylene or tricycloalkylene;
R₁ and R₂ are independently H or methyl;
with the proviso that the hydroxyl group on X₁ ring is adjacent to X₃ group, and hydroxyl group on X₂ ring is adjacent to X₄ group.

In still another aspect of the invention there is included a resin having the structure VI:

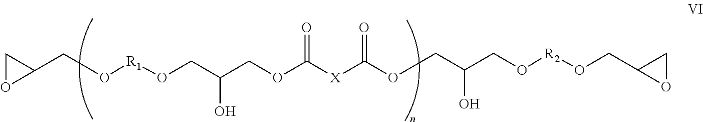

### Wherein:

R₁ and R₂ are each independently multivalent hydrocarbyl linkers. This multivalent hydrocarbyl linker is selected from linear or branched alkyls, linear or branched cycloalkyls, alkylenes, cycloalkylenes, bicycloalkylenes, tricycloalkylenes, linear or branched alkylenes, linear or branched cycloalkylenes, linear or branched alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene or heterocycloarylenes; the alkyls, cycloalkyls, alkylenes, cycloalkylenes, alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene and heterocycloarylenes can optionally contain O or S or hydroxyl group;
X is backbone of a dicarboxylic acid and is selected from arylenes, alkylenes, cycloalkylenes, linear or branched alkylenes, cycloalkylenes, bicycloalkylenes, tricycloalkylenes, linear or branched alkenylenes, arylenes, aralkylenes, cycloalkylarylenes, heterocycloalkylenes or heterocycloarylene; and
n is 1-10.

In still another aspect of the invention there is included a resin having the structure VII:

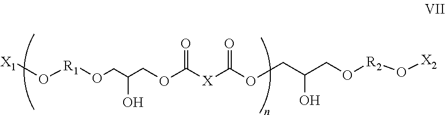

### Wherein:

R₁ and R₂ are each independently multivalent hydrocarbyl linkers, which may be selected from linear or branched alkyls, linear or branched cycloalkyls, alkylenes, cycloalkylenes, bicycloalkylenes, tricycloalkylenes, linear or branched alkylenes, linear or branched cycloalkylenes, linear or branched alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene or heterocycloarylenes, each of optionally containing O or S or a hydroxyl group;
X is backbone of a dicarboxylic acid and is selected from arylenes, alkylenes, cycloalkylenes, linear or branched alkylenes, cycloalkylenes, bicycloalkylenes, tricycloalkylenes, linear or branched alkenylenes, arylenes, aralkylenes, cycloalkylarylenes, heterocycloalkylenes or heterocycloarylene;
n is 1-10;
X₁ and X₂ are polymerizable groups and are independently selected from glycidyl or (meth)acryloyl, groups, wherein X₁ and X₂ may be same when they are not glycidyl groups.

In still another aspect of the invention there is included a resin having the structure VIII:

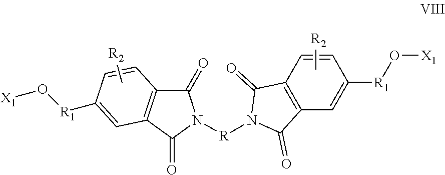

### Wherein:

R is a multivalent hydrocarbyl linker selected from linear or branched alkyls, linear or branched cycloalkyls, alkylenes, cycloalkylenes, bicycloalkylenes, tricycloalkylenes, linear or branched alkylenes, linear or branched cycloalkylenes, linear or branched alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene or heterocycloarylenes, each of which optionally containing O or S or hydroxyl group;
R₁ is a linker group, which can be a carbonyl group; an aliphatic or aromatic and may contain one or more of ester, ether, thioether or hydroxyl groups;
R₂ is a substituent on the aromatic ring, which can be H, halogen, alkyl, alkyl ether, thioether group; and
X₁ can be H or a polymerizable group selected from (meth)acryloyl and glycidyl groups.

In still another aspect of the invention there is included a resin having the structure IX:

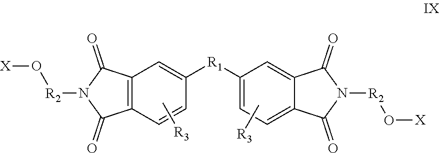

### Wherein:

R₁ can be just a bond linking the two aromatic groups; O; carbonyl; or a multivalent hydrocarbyl linker. The multivalent linker may be selected from linear or branched alkyls, linear or branched cycloalkyls, alkylenes, cycloalkylenes, bicycloalkylenes, tricycloalkylenes, linear or branched alkylenes, linear or branched cycloalkylenes, linear or branched alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene or heterocycloarylenes; the alkyls, cycloalkyls, alkylenes, cycloalkylenes, alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene and heterocycloarylenes can optionally contain O or S or hydroxyl group;
R₂ is an aliphatic or aromatic linker which may contain one or more of ester, ether, thioether, carbonate or hydroxyl groups;
R₃ is a substituent on the aryl group, which may be H, halogen, alkyl, alkyl ether, or thio ether group; and
X is H, or a polymerizable functionality selected from a (meth)acryloyl or glycidyl group.

In still another aspect of the invention there is included a resin having the structure X:

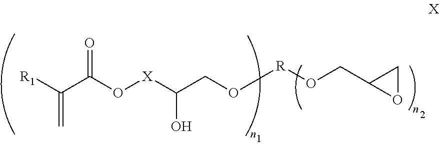

### Wherein:

R is a multivalent hydrocarbyl linker selected from linear or branched alkyls, linear or branched cycloalkyls, alkylenes, cycloalkylenes, bicycloalkylenes, tricycloalkylenes, linear or branched alkylenes, linear or branched cycloalkylenes, linear or branched alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene or heterocycloarylenes, each of which may optionally contain O, S or hydroxyl group;
R₁ is methyl or H; and
n₁ and n₂ are each independently 1-10;
X is selected from CH₂,

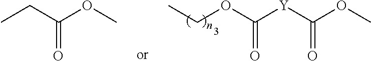

wherein n₃ is 1-10, and Y is arylene, alkylene, alkenylene, aralkylene, cycloalkylene, bicycloalkylene or tricycloalkylene.

### DETAILED DESCRIPTION

The polymers of the present invention are useful in a wide variety of applications including sealing, adhesion and coating. One particularly desirable use is as an ODF sealant for assembling LCD panels.

The present invention includes a number of novel materials including resins, oligomers and polymers useful for preparing curable compositions which may be used for ODF sealants. The present invention also includes novel compositions made from the disclosed resins. For purposes of this invention, the term “resins” will include the aforementioned the novel materials, i.e. resins, oligomers and polymers.

One aspect of the invention includes a curing resin composition for use as an ODF sealant, which includes resins represented by the general structural formulae shown above.

The glycidyl ether/ester compounds useful in synthesizing some of the inventive resins described herein is not particularly limited, and examples of the compounds available in the market include: bisphenol A type epoxy resins such as Epikote 828EL and Epikote 1004 (all manufactured by Japan Epoxy Resin Co., Ltd.); bisphenol F type epoxy resins such as Epikote 806 and Epikote 4004 (all manufactured by Japan Epoxy Resin Co., Ltd.); bisphenol S type epoxy resins such as Epiclon EXA1514 (manufactured by Dainippon Ink and Chemicals Inc.) and SE 650 manufactured by Shin A T&C; 2,2′-diallyl bisphenol A type epoxy resins such as RE-81 ONM (manufactured by Nippon Kayaku Co., Ltd.); hydrogenated bisphenol type epoxy resins such as Epiclon EXA7015 (manufactured by Dainippon Ink and Chemicals Inc.); propyleneoxide-added bisphenol A type epoxy resins such as EP-4000S (manufactured by ADEKA Corporation); resorcinol type epoxy resins such as EX-201 (manufactured by Nagase ChemteX Corporation); biphenyl type epoxy resins such as Epikote YX-4000H (manufactured by Japan Epoxy Resin Co., Ltd.); sulfide type epoxy resins such as YSLV 50TE (manufactured by Tohto Kasei Co., Ltd.); ether type epoxy resins such as YSLV 80DE (manufactured by Tohto Kasei Co., Ltd.); dicyclopentadiene type epoxy resins such as EP-4088S and EP4088L (manufactured by ADEKA Corporation); naphthalene type epoxy resins such as SE-80, SE-90, manufactured by Shin A T&C; glycidyl amine type epoxy resins such as Epikote 630 (manufactured by Japan Epoxy Resin Co., Ltd.), Epiclon 430 (manufactured by Dainippon Ink and Chemicals Inc.) and TETRAD-X (manufactured by Mitsubishi Gas Chemical Company Inc.); alkylpolyol type epoxy resins such as ZX-1542 (manufactured by Tohto Kasei Co., Ltd.), Epiclon 726 (manufactured by Dainippon Ink and Chemicals Inc.), Epolight 8OMFA (manufactured by Kyoeisha Chemical Co., Ltd.) and Denacol EX-611 (manufactured by Nagase ChemteX Corporation); rubber modified type epoxy resins such as YR-450, YR-207 (all manufactured by Tohto Kasei Co., Ltd.) and Epolead PB (manufactured by Daicel Chemical Industries, Ltd.); glycidyl ester compounds such as Denacol EX-147 (manufactured by Nagase ChemteX Corporation); bisphenol A type episulfide resins such as Epikote YL-7000 (manufactured by Japan Epoxy Resin Co., Ltd.); and others such as YDC-1312, YSLV-BOXY, YSLV-90CR (all manufactured by Tohto Kasei Co., Ltd.), XAC4151 (manufactured by Asahi Kasei Corporation), Epikote 1031, Epikote 1032 (all manufactured by Japan Epoxy Resin Co., Ltd.), EXA-7120 (manufactured by Dainippon Ink and Chemicals Inc.), TEPIC (manufactured by Nissan Chemical Industries, Ltd.). Examples of the commercially available phenol novolak type epoxy compound include Epiclon N-740, N-770, N-775 (all manufactured by Dainippon Ink and Chemicals Inc.), Epikote 152, Epikote 154 (all manufactured by Japan Epoxy Resin Co., Ltd.), and the like. Examples of the commercially available cresol novolak type epoxy compound include Epiclon N-660, N-665, N-670, N-673, N-680, N-695, N-665-EXP and N-672-EXP (all manufactured by Dainippon Ink and Chemicals Inc.); an example of the commercially available biphenyl novolak type epoxy compound is NC-3000P (manufactured by Nippon Kayaku Co., Ltd.); examples of the commercially available trisphenol novolak type epoxy compound include EP1032S50 and EP1032H60 (all manufactured by Japan Epoxy Resin Co., Ltd.); examples of the commercially available dicyclopentadiene novolak type epoxy compound include XD-1000-L (manufactured by Nippon Kayaku Co., Ltd.) and HP-7200 (manufactured by Dainippon Ink and Chemicals Inc.); examples of the commercially available bisphenol A type epoxy compound include Epikote 828, Epikote 834, Epikote 1001, Epikote 1004 (all manufactured by Japan Epoxy Resin Co., Ltd.), Epiclon 850, Epiclon 860 and Epiclon 4055 (all manufactured by Dainippon Ink and Chemicals Inc.); examples of the commercially available bisphenol F type epoxy compound include Epikote 807 (manufactured by Japan Epoxy Resin Co., Ltd.) and Epiclon 830 (manufactured by Dainippon Ink and Chemicals Inc.); an example of the commercially available 2,2′-diallyl bisphenol A type epoxy compound is RE-810NM (manufactured by Nippon Kayaku Co., Ltd.); an example of the commercially available hydrogenated bisphenol type epoxy compound is ST-5080 (manufactured by Tohto Kasei Co., Ltd.); examples of the commercially available polyoxypropylene bisphenol A type epoxy compound include EP-4000 and EP-4005 (all manufactured by ADEKA Corporation); and the like. HP4032 and Epiclon EXA-4700 (all manufactured by Dainippon Ink and Chemicals Inc.); phenol novolak type epoxy resins such as Epiclon N-770 (manufactured by Dainippon Ink and Chemicals Inc.); orthocresol novolak type epoxy resins such as Epiclon N-670-EXP-S (manufactured by Dainippon Ink and Chemicals Inc.); dicyclopentadiene novolak type epoxy resins such as Epiclon HP7200 (manufactured by Dainippon Ink and Chemicals Inc.); biphenyl novolak type epoxy resins such as NC-3000P (manufactured by Nippon Kayaku Co., Ltd.); and naphthalene phenol novolak type epoxy resins such as ESN-165S (manufactured by Tohto Kasei Co., Ltd.).

Examples of the alicyclic epoxy compounds useful in synthesizing some of the inventive resins include, without limitation, polyglycidyl ethers of polyhydric alcohols having at least one alicyclic ring and cyclohexene oxide- or cyclopentene oxide containing compounds obtained by epoxidizing cyclohexene ring or cyclopentene ring-containing compounds. Specific examples include hydrogenated bisphenol A diglycidyl ether, 3,4-epoxycyclohexylmethyl 3,4-epoxycyclohexanecarboxylate, 3,4-epoxy-1-methyl cyclohexyl-3,4-epoxy-1-methylcyclohexanecarboxylate, 6-methyl-3,4-epoxycyclohexylmethyl-6-methyl-3,4-epoxy-cyclohexanecarboxylate, 3,4-epoxy-3-methylcyclohexylmethyl 3,4-epoxy-3-methylcyclohexanecarboxylate, 3,4-epoxy-5-methylcylcohexylmethyl-3,4-epoxy-5-methylcyclohexanecarboxylate, 2-(3,4-epoxycyclohexyl-5,5-spiro-3,4-epoxy)cyclohexane-metadioxane, bis(3,4-epoxycyclohexylmethyl)adipate, 3,4-epoxy-6-methylcyclohexyl carboxylate, methylenebis(3,4-epoxycyclohexane), dicyclopentadiene diepoxide, ethylenebis(3,4-epoxycyclohexanecarboxylate), dioctylepoxyhexahydrophthalate, and di-2-ethylhexyl epoxyhexahydrophthalate.

Some of these alicyclic epoxy resins are commercially available as: UVR-6100, UVR-6105, UVR-6110, UVR-6128, and UVR-6200 (products of Dow Corporation); CELLOXIDE 2021, CELLOXIDE 2021P, CELLOXIDE 2081, CELLOXIDE 2083, CELLOXIDE 2085, CELLOXIDE 2000, CELLOXIDE 3000, CYCLMER A200, CYCLMER M100, CYCLMER M101, EPOLEAD GT-301, EPOLEAD GT-302, EPOLEAD 401, EPOLEAD 403, ETHB, and EPOLEADHD 300 (products of Daicel Chemical Industries, Ltd.); KRM-2110 and KRM-2199 (products of ADEKA Corporation).

In addition to the curable polymers of the present invention, ODF sealant compositions may also include a free radical initiator (thermal or UV generated) and a curing agent. Curing of the ODF compositions may be by thermal or UV mechanisms or both. In embodiments where an epoxide ring is present, a latent epoxy curing agent may also be employed.

Useful thermal free radical initiators include, for example, organic peroxides and azo compounds that are known in the art. Examples include: azo free radical initiators such as AIBN (azodiisobutyronitrile), 2,T-azobis(4-methoxy-2,4-dimethyl valeronitrile), 2,2′-azobis(2,4-dimethyl valeronitrile), dimethyl 2,2′-azobis(2-ethylpropionate), 2,2′-azobis(2-methylbutyronitrile), 1,11-azobis(cyclohexane-1-carbonitrile), 2,2′-azobis[N-(2-propenyl)-2-methylpropionamide]; dialkyl peroxide free radical initiators such as 1,1-di-(butylperoxy-3,3,5-trimethyl cyclohexane); alkyl perester free radical initiators such as TBPEH (t-butyl per-2-ethylhexanoate); diacyl peroxide free radical initiators such as benzoyl peroxide; peroxy dicarbonate radical initiators such as ethyl hexyl percarbonate; ketone peroxide initiators such as methyl ethyl ketone peroxide, bis(t-butyl peroxide) diisopropylbenzene, t-butylperbenzoate, t-butyl peroxy neodecanoate, and combinations thereof.

Further examples of organic peroxide free radical initiators include: dilauroyl peroxide, 2,2-di(4,4-di(tert-butylperoxy)cyclohexyl)propane, di(tert-butylperoxyisopropyl) benzene, di(4-tert-butylcyclohexyl) peroxydicarbonate, dicetyl peroxydicarbonate, dimyristyl peroxydicarbonate, 2,3-dimethyl-2,3-diphenylbutane, dicumyl peroxide, dibenzoyl peroxide, diisopropyl peroxydicarbonate, tert-butyl monoperoxymaleate, 2,5-dimethyl-2,5-di(tert-butylperoxy)hexane, tert-butylperoxy 2-ethylhexyl carbonate, tert-amyl peroxy-2-ethylhexanoate, tert-amyl peroxypivalate, tert-amylperoxy 2-ethylhexyl carbonate, 2,5-dimethyl-2,5-di(2-ethylhexanoylperoxy) hexane 2,5-dimethyl-2,5-di(tert-butylperoxy) hexpe-3, di(3-methoxybutyl)peroxydicarbonate, diisobutyryl peroxide, tert-butyl peroxy-2-ethylhexanoate (Trigonox 21 S), 1,1-di(tert-butylperoxy)cyclohexane, tert-butyl peroxyneodecanoate, tert-butyl peroxypivalate, tert-butyl peroxyneoheptanoate, tert-butyl peroxydiethylacetate, 1,1-di(tert-butylperoxy)-3,3,5-trimethylcyclohexane, 3,6,9-triethyl-3,6,9-trimethyl-1,4,7-triperoxonane, di(3,5,5-trimethylhexanoyl) peroxide, tert-butyl peroxy-3,5,5-trimethyl hexanoate, 1,1,3,3-tetramethylbutyl peroxy-2-ethylhexanoate, 1,1,3,3-tetramethylbutyl peroxyneodecanoate, tert-butyl peroxy-3,5,5-trimethyl hexanoate, cumyl peroxyneodecanoate, di-tert-butyl peroxide, tert-butylperoxy isopropyl carbonate, tert-butyl peroxybenzoate, di(2-ethylhexyl) peroxydicarbonate, tert-butyl peroxyacetate, isopropylcumyl hydroperoxide, and tert-butyl cumyl peroxide.

Ordinarily the thermal free radical initiator with higher decomposition rate is preferred, as this can generate free radicals more easily at common cure temperature (80-130° C.) and give faster cure speed, which can reduce the contact time between liquid resin and liquid crystal, and reduce the liquid crystal contamination. On the other hand, if the decomposition rate of initiator is too high, the viscosity stability at room temperature will be influenced and thereby reducing the work life of the sealant.

A convenient way of expressing the decomposition rate of an initiator at a specified temperature is in terms of its half-life i.e., the time required to decompose one-half of the peroxide originally present. To compare reactivity of different initiators, the temperature at which each initiator has a half-life (T½) of 10 hours is used. The most reactive (fastest) initiator would be the one with the lowest 10 h T½ temperature.

The thermal free radical initiator with 10 h T½ temperature of 30-80° C. is preferred, and the thermal free radical initiator with 10 h T½ temperature of 40-70° C. is more preferred.

To balance the reactivity and viscosity stability of the composition, the thermal free radical initiator used in the resin composition is in an amount of usually 0.01 to 3 parts by weight, and preferably 0.5 to 2 parts by weight, based on 100 parts by weight of the inventive resin in the curable composition of the present invention.

Useful UV free radical initiators include Norrish type I cleavage photoinitiators that are commercially available from CIBA and BASF. These photoinitiators are used in the amount 0.1-5 wt %, more preferably in about 0.2 to 3 wt % in the formulation.

Examples of useful epoxy curing agent include but are not limited to the Ajicure series of hardeners available from Ajinomoto Fine-Techno Co., Inc.; the Amicure series of curing agents available from Air products and the JERCURE™ products available from Mitsubushi Chemical. These curing agents or hardeners or hardeners are used in the amount of about 1% to about 50% by weight of the total composition, more preferably from about 5% to about 20% by weight of the total composition.

The curable composition may optionally contain, as desired, a further component capable of a photopolymerization reaction such as a vinyl ether compound. In addition, the curable composition may further comprise additives, resin components and the like to improve or modify properties such as flowability, dispensing or printing property, storage property, curing property and physical property after curing.

Various additives may be contained in the composition as desired, for example, organic or inorganic fillers, thixotropic agents, silane coupling agents, diluents, modifiers, coloring agents such as pigments and dyes, surfactants, preservatives, stabilizers, plasticizers, lubricants, defoamers, leveling agents and the like; however it is not limited to these. In particular, the composition preferably comprises an additive selected from the group consisting of organic or inorganic filler, a thixotropic agent, and a silane coupling agent. These additives may be present in amounts of about 0.1% to about 50% by weight of the total composition, more preferably from about 2% to about 10% by weight of the total composition.

The filler may include, but is not limited to, inorganic fillers such as silica, diatomaceous earth, alumina, zinc oxide, iron oxide, magnesium oxide, tin oxide, titanium oxide, magnesium hydroxide, aluminium hydroxide, magnesium carbonate, barium sulphate, gypsum, calcium silicate, talc, glass bead, sericite activated white earth, bentonite, aluminum nitride, silicon nitride, and the like; meanwhile, organic fillers such as poly(methyl) methacrylate, poly(ethyl) methacrylate, poly(propyl) methacrylate, poly(butyl) methacrylate, butylacrylate-methacrylic acid-(methyl) methacrylate copolymer, polyacrylonitrile, polystyrene, polybutadiene, polypentadiene, polyisoprene, polyisopropylene, and the like. These may be used alone or in combination. These fillers may be present in amounts of about 1% to about 80%, more preferably from about 5% to about 30% by weight of the total composition.

The thixotropic agent may include, but is not limited to, talc, fume silica, superfine surface-treated calcium carbonate, fine particle alumina, plate-like alumina; layered compounds such as montmorillonite, spicular compounds such as aluminium borate whisker, and the like. Among them, talc, fume silica and fine alumina are particularly desired. These agents may be present in amounts of about 1% to about-50%, more preferably from about 1% to about 30% by weight of the total composition.

The silane coupling agent may include, but is not limited to, γ-minopropyltriethoxysilane, γ-mercaptopropyltrimethoxysilane, γ-methacryloxypropyltrimethoxysilane, γ-glycidoxypropyltrimethoxylsilane, and the like.

The curable composition according to the present invention may be obtained by mixing the aforementioned each component by means of, for example, a mixer such as a stirrer having stirring blades and a three roll mill. The composition is liquid at ambient with the viscosity of 200-400 Pa·s (at 25° C.) at 1.5 s−1 shear rate, which allows for easy dispensing.

Also provided is a method for manufacturing a liquid crystal display having a liquid crystal layer between a first substrate and a second substrate, by means of a liquid crystal one-drop-filling process. The method comprises the steps of

(a) applying the curable composition described in the present invention on a sealing region at periphery of a surface of the first substrate;
(b) dropping liquid crystal on a central area encircled by the sealing region of the surface of the first substrate;
(c) overlaying the second substrate on the first substrate;
(d) optionally performing partial curing by UV-irradiating the curable composition, and
(e) performing final curing by heating the curable composition.

The first substrate and the second substrate used in the present invention are usually transparent glass substrates. Generally, transparent electrodes, active matrix elements (such as TFT), alignment film(s), a color filter and the like are formed on at least one of the opposed faces of the two substrates. These constitutions may be modified according to the type of the LCD. The manufacturing method according to the present invention may be thought to be applied for any type of the LCD.

In step (a), the curable composition is applied on the periphery portion of the surface of the first substrate so as to lap around the substrate circumference in a frame shape. The portion where the curable composition is applied in a frame shape is referred as a seal region. The curable composition can be applied by a known method such as screen printing and dispensing.

In step (b), the liquid crystal is then dropped onto the center region surrounded by the seal region in the frame shape on the surface of the first substrate. This step is preferably conducted under reduced pressure.

In step (c), said second substrate is then placed over said first substrate, and UV-irradiated in the step (d). By the UV-irradiation, the curable composition cures partially and shows the strength at a level that displacement does not occur by handling, whereby the two substrates are temporally fixed. Generally, the radiation time is preferably short, for example not longer than 5 minutes, preferably not longer than 3 minutes, more preferably not longer than 1 minute.

In step (e), heating the curable composition allows it to achieve the final curing strength, whereby the two substrates are finally bonded. The thermal curing in the step (e) is generally heated at a temperature of 80 to 130° C., and preferably of 100 to 120° C., with the heating time of 30 mins to 3 hours, typically 1 hour.

By this process, the major part of the LCD panel is completed.

### Performance Data for ODF Formulations

Table I below shows inventive ODF formulations 2-7 and control formulation 1 containing commercially available Uvacure 1561, which is partially acrylated BPA diglycidyl ether. Irgacure 651 is a commercially available photoinitiator; A-187 is an adhesion promoter; EH-4357S is an epoxy hardener; SO-E2 is a silica filler;

TABLE 1

| | ODF formulations | | | | | | |
|---|---|---|---|---|---|---|---|
| Materials | 1 | 2 | 3 | 4 | 5 | 6 | 7 |
| Uvacure 1561 | 66 | 40 | 40 | 40 | 40 | 40 | 40 |
| Resin 1 | | 26 | | 13 | 13 | | |
| Resin 2 | | | 26 | | | | |
| Resin 10 | | | | 13 | | | |
| Resin 3 | | | | | 13 | | |
| Resin 5 | | | | | | 26 | |
| Resin 8 | | | | | | | 26 |
| Irgacure 651 | 0.6 | 0.6 | 0.6 | 0.6 | 0.6 | 0.6 | 0.6 |
| A-187 | 1 | 1 | 1 | 1 | 1 | 1 | 1 |
| SO-E2 | 15.95 | 15.95 | 15.95 | 15.95 | 15.95 | 15.95 | 15.95 |
| EH-4357S | 16.45 | 9.97 | 15.45 | 13.28 | 11.83 | 15.15 | 13.58 |
| Total | 100.00 | 93.52 | 99.00 | 96.83 | 95.38 | 98.70 | 97.13 |
| VHR, LC25 (5 V, 6 | 95.98 | 94.03 | 93.97 | 94.99 | 95.17 | 95.74 | 95.09 |
| Hz) | | | | | | | |
| Mocon | 8.29 | 6.67 | 8.65 | 8.10 | 6.29 | 9.32 | 6.64 |
| g · mil/(100 in 2 · | | | | | | | |
| day), 50° C./100RH | | | | | | | |
| Corner Strength, | 8.34 | 9.10 | 9.70 | 8.28 | 8.64 | 8.05 | 8.76 |
| N/mm, ITO to ITO | | | | | | | |
| glass | | | | | | | |
| Corner Strength | 7.19 | 8.02 | 7.11 | 5.67 | 5.33 | 5.59 | 8.69 |
| after PCT(121° | | | | | | | |
| C., 100% RH, 2 | | | | | | | |
| atm, 24 h), N/mm | | | | | | | |

As indicated in Table I, several inventive formulations showed improved moisture barrier properties and adhesion (measured as corner strength)

### Syntheses

General Procedure for Glycidyl Ether Ring Opening with (Meth)Acrylic Acid and 6-Maleimidocaproic Acid

In a round bottom flask equipped with a mechanical stirrer and nitrogen inlet were taken epoxy resin and appropriate stoichiometry of methacrylic acid or 6-maleimidocaproic acid in toluene. Methylhydroquinone (1000-3000 ppm) and Hycat 2000S epoxy ring opening catalyst (1 wt %) were added and the mixture stirred at 60° C. for about 24 h. After cooling to room temperature (room temperature), an appropriate amount of ethyl acetate was added and the mixture was washed twice with aqueous NaHCO₃ solution and several times with deionized water. After drying over anhydrous Na₂SO₄, the solvent was passed through a silica column. Another 500 ppm of methylhydroquinone was added and the solvent evaporated to give partially or completely ring-opened epoxy-(meth)acrylate or epoxy-maleimides resins.

General Procedure For Chain Extension of Diglycidyl Ethers with Dicarboxylic Acid to Obtain Epoxy Terminated Oligomers and Capping with Methacrylic Acid

In a multi necked flask equipped with a mechanical stirrer were taken diglycidyl ether (2 eq), dicarboxylic acid (1 eq), Hycat 2000S epoxy ring opening catalyst (1 wt %) in a mixture of toluene and tetrahydrofuran (THF) (2:1). The mixture was stirred at 60° C. for 15 hrs and 70° C. for 12 hrs to give the chain extended epoxy resin, which can be capped in the same reaction pot by adding methacrylic acid. After cooling to room temperature, ethyl acetate was added and the mixture washed with aqueous NaHCO₃ solution twice and several times with deionized water. After drying over anhydrous Na₂SO₄, the organic layer was passed through a silica column and the solvent evaporated to give chain extended epoxy resin. The molecular weight of the oligomer obtained can be altered by changing the diglycidyl ether to dicarboxylic acid ratio.

### Inventive Resin Syntheses

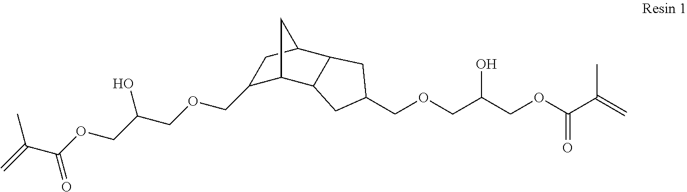 [SMILES: C=C(C)C(=O)OCC(O)COCC1CC2C3CC(COCC(O)COC(=O)C(=C)C)C(C3)C2C1]

### Preparation of Inventive Resin 1

In a 1 L 4 necked flask equipped with a mechanical stirrer and nitrogen inlet were taken EP4088S (123.6 g, 400 mmol), methacrylic acid (86.2 g, 1000 mmol), MeHQ (100 mg, 500 ppm), Hycat 2000S (2.1 g, 1 wt %) and toluene (200 mL). The mixture was stirred at 60° C. overnight. After cooling to room temperature 500 mL of ethyl acetate was added and the mixture washed twice with aqueous NaHCO₃ solution and several times with deionized water. After drying over anhydrous Na₂SO₄ the solvent was passed through a silica column. Another 500 ppm of MeHQ was added and the solvent evaporated to give dimethacrylate resin 1 (182 g, 87%).

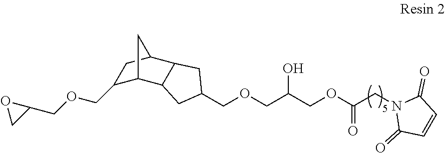

### Preparation of Inventive Resin 2

In a 500 mL 4 necked flask equipped with a mechanical stirrer and nitrogen inlet were taken EP4088S (101 g, 327 mmol) and 6-maleimidocaproic acid (96.8 g, 458 mmol), methylhydroquinone (100 mg, 500 ppm) in toluene (130 mL). 2 g of Hycat 2000S (1 wt %) was added and the mixture was stirred at 60° C. for about 16 h. After cooling to room temperature, ethyl acetate was added and the product washed with aqueous NaHCO₃ solution twice to remove any residual maleimidocaproic acid. The organic layer was then washed several times with deionized water and dried over anhydrous Na₂SO₄. The organic layer was then passed through a silica column and the solvent evaporated to give hybrid epoxy-maleimide resin 2 (170 g, 85%).

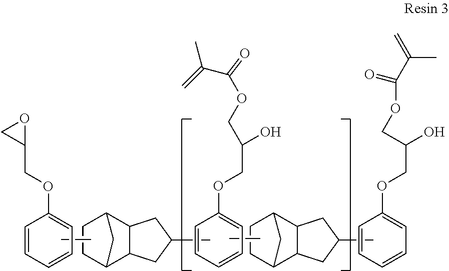

### Preparation of Inventive Resin 3

In a 500 mL 4 necked flask equipped with a mechanical stirrer was taken Tactix 756 (70.6 g, 280 mmoles per epoxy) methacrylic acid (16.03 g, 186 mmol), Hycat 2000S (0.86 g, 1 wt %) and toluene (100 mL). 500 ppm of methylhydroquinone (40 mg) was added and the mixture stirred at 60° C. overnight. After cooling to room temperature, 300 mL of ethyl acetate was added and the organic layer washed twice with aqueous NaHCO₃ solution and several times with deionized water. After drying over anhydrous Na₂SO₄, the organic layer was passed through a column containing silica gel. 200 mg of methylhydroquinone (2000 ppm) was added and the solvent evaporated to give the dimethacrylate resin 3 was a brown solid (62 g, 72%, loss in yield due to difficulty in taking out all of the solid material from the flask).

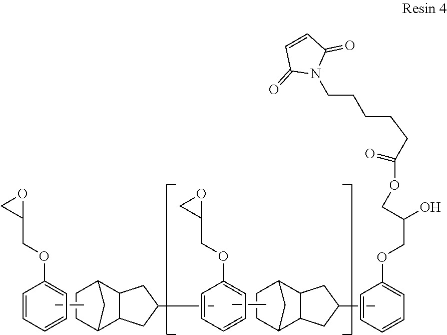

### Preparation of Inventive Resin 4

In a 500 mL 4 necked flask equipped with a mechanical stirrer were taken Tactix 756 (92.5 g, 366 mmol, with respect to epoxy functionality), 6-maleimidocaproic acid (25.8 g, 122 mmol), methylhydroquinone (63 mg, 500 ppm). Toluene (200 mL) was added and the mixture stirred at 60° C. until it became homogenous. Hycat 2000S was added (1.26 g, 1 wt %) and the mixture stirred at the same temperature for about 16 h. After cooling to room temperature, 400 mL of ethyl acetate was added and the organic layer washed twice with aqueous NaHCO₃ solution and several times with deionized water. After drying over anhydrous Na₂SO₄, the organic layer was passed through a silica column and the solvent evaporated to give hybrid epoxy-maleimide resin 4 (92 g, 78%).

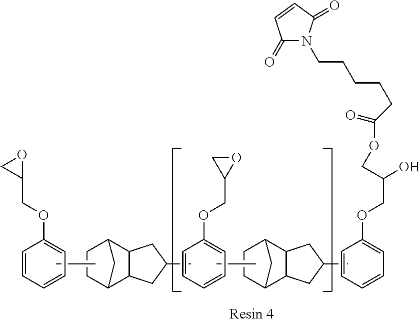

### Preparation of Inventive Resin 5

In a 1 L 4 necked flask equipped with a mechanical stirrer were taken Bisphenol A diglycidyl ether (121 g, 355 mmol), 6-maleimidocaproic acid (105 g, 497 mmol), methylhydroquinone (110 mg, 500 ppm) in toluene (200 mL). The mixture was stirred at 60° C. until it became homogenous. Hycat 2000S (2.2 g, 1 wt %) was added and the mixture stirred at the same temperature overnight. After cooling to room temperature 1 L of ethyl acetate was added and the organic layer washed twice with aqueous NaHCO₃ solution and several times with deionized water. After drying over anhydrous Na₂SO₄, the organic layer was passed through a silica column and the solvent evaporated to give the hybrid epoxy maleimide resin 5 (175 g, 77%).

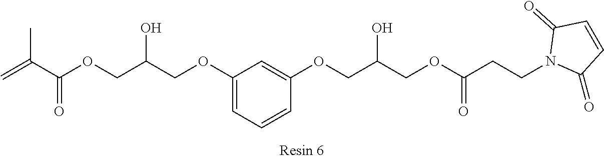 [SMILES: C=C(C)C(=O)OCC(O)COc1cccc(OCC(O)COC(=O)CCN2C(=O)C=CC2=O)c1]

### Preparation of Inventive Resin 6

In a 500 mL 4 necked flask equipped with a mechanical stirrer were taken resorcinol diglycidyl ether (101 g, 454 mmol), methacrylic acid (54.8 g, 636 mmol), 3-maleimidopropanoic acid (50 g, 295 mmol), methylhydroquinone (100 mg, 500 ppm) and Hycat 2000S (2 g, 1 wt %) in toluene (200 mL) and the mixture heated at 60° C. overnight. After cooling to room temperature 500 mL of ethyl acetate was added and the organic layer washed twice with aqueous NaHCO₃ solution and several times with deionized water. After drying over anhydrous Na₂SO₄, the organic layer was passed through silica column. 500 ppm of methylhydroquinone was added and the solvent evaporated to give RDGE hybrid maleimido-methacrylate resin 6 as a viscous liquid (165 g, 80%).

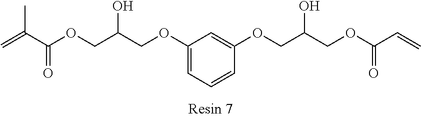 [SMILES: C=CC(=O)OCC(O)COc1cccc(OCC(O)COC(=O)C(=C)C)c1]

### Preparation of Inventive Resin 7

In a 500 mL 4 necked flask equipped with a mechanical stirrer was taken resorcinol diglycidyl ether (93.2 g, 419 mmol), acrylic acid (33.2 g, 251 mmol), methacrylic acid (39.7 g, 251 mmol), methylhydroquinone (130 mg, 1000 ppm) and Hycat 2000S (1.3 g, 1 wt %) in toluene (200 mL) and the mixture was heated at 60° C. overnight. After cooling to room temperature 500 mL of ethyl acetate was added and the organic layer washed twice with aqueous NaHCO₃ solution and several times with deionized water, dried over anhydrous Na₂SO₄. The organic layer was directly passed through a column of silica gel & 500 ppm of methylhydroquinone was added and the solvent evaporated to give the hybrid acrylate-methacrylate resin 7 (123 g, 92%).

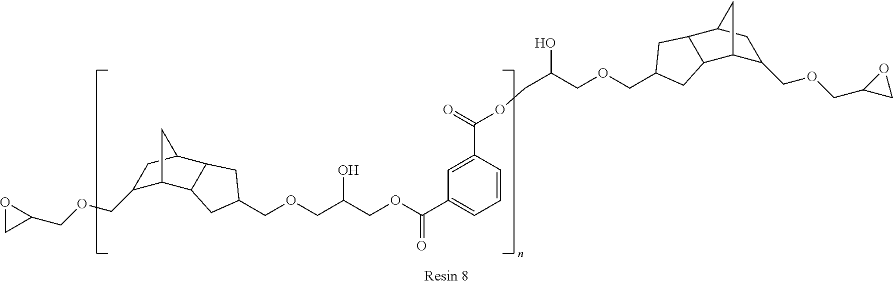

### Preparation of Inventive Resin 8

In a 500 mL 3 necked flask equipped with a magnetic stirrer were taken EP4088S epoxy resin (133.3 g, 432 mmol), isophthalic acid (35.9 g, 216 mmol), Hycat 2000S (1.7 g, 1 wt %) in mixture of toluene (200 mL) and THF 100 mL). The mixture was stirred at 60° C. for 15 h and 70° C. for 12 h. After cooling to room temperature 500 mL of ethyl acetate was added and the mixture washed with aqueous NaHCO₃ solution twice and several times with deionized water. After drying over anhydrous Na₂SO₄, the organic layer was passed through a silica column and the solvent evaporated to give chain extended EP 4088S epoxy resin 8 (132 g, 78%) as a viscous liquid. The molecular weight of the chain extended resin can be altered by changing the ratio of the diacid to the diglycidyl ether.

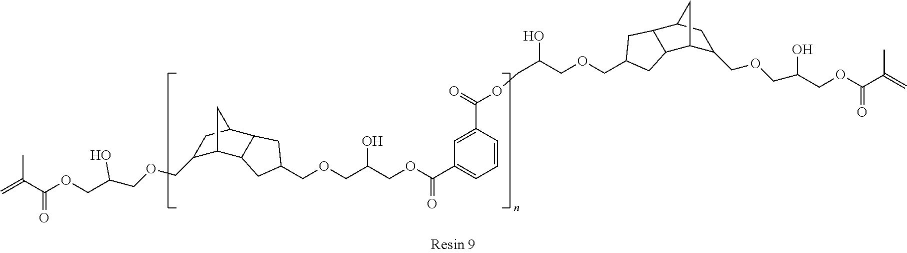

### Preparation of Inventive Resin 9

In a 500 mL 3 necked flask equipped with a mechanical stirrer were taken EP4088S (168 g, 545 mmol) isophthalic acid (45.33 g, 272 mmol) in a mixture of toluene (200 g) and THF (100 mL). The mixture was stirred at 60° C. for 15 minutes. Hycat 2000S (2.1 g, 1 wt %) was added and the mixture stirred at the same temperature until for about 12 h and at 70° C. for 8 h at which time the mixture becomes homogenous. Methacrylic acid (56.3 g, 654 mmol) and additional Hycat (2.1 g, 1 wt %) were added and the mixture further stirred overnight. THF was evaporated and 700 mL ethyl acetate added. The organic layer washed twice times with aqueous NaHCO₃ solution and several times with deionized water. The organic layer was passed through a silica column and the solvent evaporated to give the methacrylate end capped chain extended DCPD oligomer (resin 9) as a highly viscous liquid (160 g, 78%)

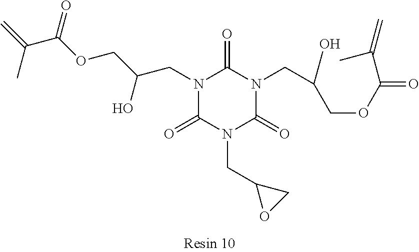 [SMILES: C=C(C)C(=O)OCC(O)Cn1c(=O)n(CC(O)COC(=O)C(=C)C)c(=O)n(CC2CO2)c1=O]

### Preparation of Inventive Resin 10

In a 500 mL round bottom flask equipped with a magnetic stir bar and a nitrogen inlet were taken tris(2,3-epoxypropyl) isocyanurate (62 g, 209 mmol) and methacrylic acid (35.9 g, 418 mmol) in toluene (200 mL). 1000 ppm of methylhydroquinone and Hycat 2000S (1 g, 1 wt %) were added and the mixture heated at 60° C. overnight. After cooling to room temperature ethyl acetate was added and the organic layer washed with saturated aqueous bicarbonate solution twice followed by deionized water several times. After drying over anhydrous Na₂SO₄, the organic layer was passed through a silica column and the solvent evaporated. This gave the epoxy dimethacrylate resin 10 as a viscous liquid (73 g, 74%).

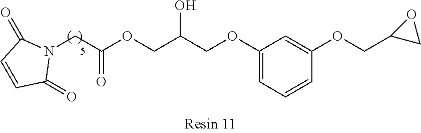 [SMILES: O=C(CN1C(=O)C=CC1=O)OCC(O)COc1cccc(OCC2CO2)c1]

### Preparation of Inventive Resin 11

In a 500 mL 4 necked flask equipped with a mechanical stirrer were taken RDGE (93.4 g, 420 mmol), 6-maleimidocaproic acid (124.2 g, 588 mmol), methylhydroquinone (100 mg, 500 ppm) in toluene (200 mL) and the mixture was heated at 60° C. until it became homogenous. Hycat 2000S (2.05 g, 1 wt %) was added and the mixture stirred at 60° C. overnight. Next day morning, after cooling to room temperature 500 mL of ethyl acetate was added and the organic layer washed twice with aqueous NaHCO₃ solution and several times with deionized water. After drying over anhydrous Na₂SO₄ the organic layer was passed through a silica column and the solvent evaporated. 500 ppm of MeHQ was added and the solvent evaporated to give resin 11 as a light brown viscous liquid (158 g, 73%).

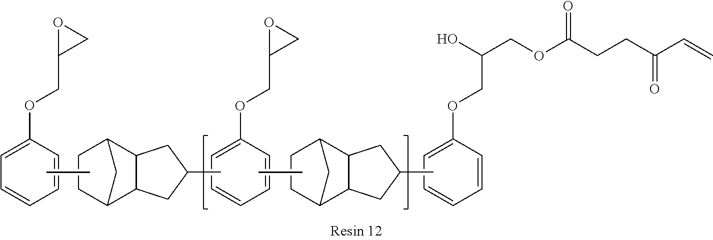

### Preparation of Inventive Resin 12

Into a 100 mL round bottom flask was added 20.0 g of Tactix 756 (Huntsman Advanced Materials) and 20.0 g of SR833 (Sartomer). This mixture was heated to 100° C. in air with stirring. A homogeneous solution was obtained in about half an hour. The reaction was cooled to 70° C. and 6.62 g 2-carboxyethyl acrylate (CEA) and 0.45 g 2-(dimethylamino)ethyl acrylate (DMAEA) were added. The reaction continued in air for 4 h. ¹H NMR indicated complete consumption of the acid. The formation of adduct was further confirmed by mass spectroscopy.

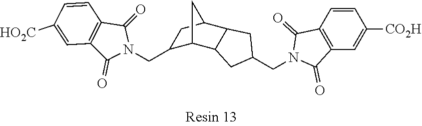 [SMILES: O=C(O)c1ccc2c(c1)C(=O)N(CC1CC3C4CC(CN5C(=O)c6ccc(C(=O)O)cc6C5=O)C(C4)C3C1)C2=O]

### Preparation of Inventive Resin 13

In a 1 L 4 necked flask equipped with a mechanical stirrer was taken trimellitic anhydride (154 g, 802 mmol) in a mixture of DMF (500 mL) and xylene (100 mL). To this was added tricyclodecane diamine (Oxea chemicals, 78 g, 401 mmol) and the mixture stirred at room temperature until it becomes almost homogenous. The mixture was heated and when the temperature reaches about 130° C., the mixture begins to reflux. The mixture was refluxed for 1 h and the mixture concentrated by distilling out the solvent mixture. The distillation starts around 138° C. and the pot temperature gradually increases to about 172° C. After most of the solvent has been distilled off, the mixture was poured into excess water and stirred for 2 h. It takes a while for the gel like material to solidify. The resulting white precipitate was filtered off and the filter cake was washed twice with water. The solid was dried to give resin 13 as a white powder (174 g, 80%).

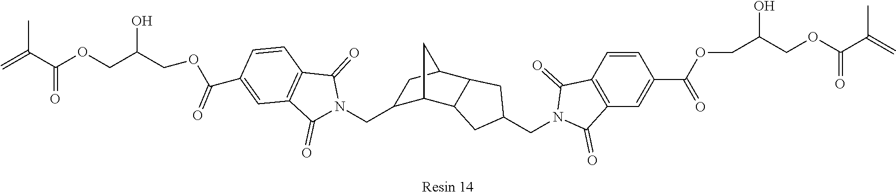 [SMILES: C=C(C)C(=O)OCC(O)COC(=O)c1ccc2c(c1)C(=O)N(CC1CC3C4CC(CN5C(=O)c6ccc(C(=O)OCC(O)COC(=O)C(=C)C)cc6C5=O)C(C4)C3C1)C2=O]

### Preparation of Inventive Resin 14

In a 500 ml 4 necked flask equipped with a mechanical stirrer and condenser were taken imide imide diacid resin 13 (57.5 g, 105 mmol) and glycidyl methacrylate (28.6 g, 201 mmol) in THF (150 mL). Hycat 2000S (0.9 g, 1 wt %) was added and the mixture stirred at 60° C. overnight. THF was evaporated and 600 mL ethyl acetate was added. The organic layer was washed twice with aqueous NaHCO₃ solution, several times with deionized water and passed through a silica column. Another 1000 ppm of MeHQ was added and the solvent evaporated to give resin 14 as a light green solid (90%).

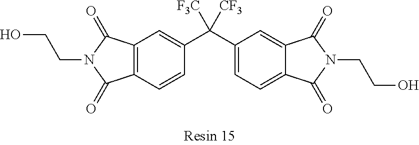 [SMILES: O=C1c2ccc(C(c3ccc4c(c3)C(=O)N(CCO)C4=O)(C(F)(F)F)C(F)(F)F)cc2C(=O)N1CCO]

### Preparation of Inventive Resin 15

4,4′-Hexaflurorisopropylidenediphthaleic anhydride (100 g, 225 mmol) was taken in a mixture of DMF (400 mL) and xylene (80 mL) in a 1 L 3 necked flask equipped with a mechanical stirrer and heating mantle. Ethanolamine (31 g, 506 mmol) was added at once (slightly exothermic, as the temp rose to about 45° C.). The mixture was heated to 170° C. as the reaction temperature gradually rose to about 139° C. when the azeotropic distillation started. The temperature eventually rose to about 160° C. in about 30 minutes. At this point, the reaction was stopped and IR indicated that the imidization reached completion. After cooling, 500 mL of water was added and stirred for 30 minutes. The precipitated solid was filtered off and washed several times with water and dried to give imide diol resin 15 as a light orange solid (101 g, 85%).

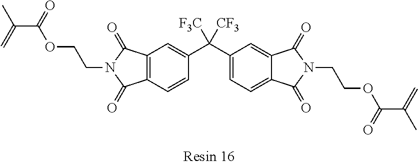 [SMILES: C=C(C)C(=O)OCCN1C(=O)c2ccc(C(c3ccc4c(c3)C(=O)N(CCOC(=O)C(=C)C)C4=O)(C(F)(F)F)C(F)(F)F)cc2C1=O]

### Preparation of Inventive Resin 16

In a 1 L 3 necked flask equipped with a mechanical stirrer and water condenser, were taken imide diol 15 (42 g, 79 mmol), methacrylic acid (17 g, 198 mmol), PTSA mono hydrate (1.5 g, 7.9 mmol), 4-methoxyphenol (60 mg, 1000 ppm) in toluene (300 mL). The mixture was refluxed with azeotrope distillation of water for about 7 h. After cooling to room temperature, the mixture was diluted with ethyl acetate, washed with aqueous NaHCO₃ solution twice, deionized water until the ionic conductivity was about 2 uS. The organic layer was passed through a silica column containing a short plug of sillitin in between the silica layers. Another 500 ppm pf 4-methoxyphenol was added and the solvent evaporated on rotovap to give resin 16 (43 g, 81%).

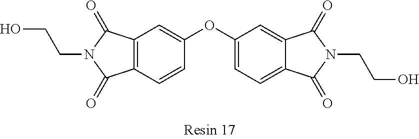 [SMILES: O=C1c2ccc(Oc3ccc4c(c3)C(=O)N(CCO)C4=O)cc2C(=O)N1CCO]

### Preparation of Inventive Resin 17

4,4′-Oxydiphthaleic anhydride (104 g, 335 mmol) was taken in a mixture of DMF (400 mL) and xylene (100 mL) in a 1 L 3 necked flask equipped with a mechanical stirrer and heating mantle. Ethanolamine (47 g, 769 mmol) was added at once (slightly exothermic, as the temp rose to about 48° C.). The mixture was heated to 170° C. as the reaction temperature gradually rose to about 139° C. when the azeotropic distillation started. The temperature eventually rose to about 170° C. in about 30 minutes. After most of the solvent has distilled off, the mixture was cooled to room temperature 500 mL of water was added and stirred well for 30 minutes. The precipitated white solid was filtered off, washed several times with water and dried to give the imide dial resin 17 as an off white solid (108 g, 81%).

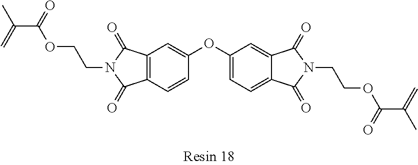 [SMILES: C=C(C)C(=O)OCCN1C(=O)c2ccc(Oc3ccc4c(c3)C(=O)N(CCOC(=O)C(=C)C)C4=O)cc2C1=O]

### Preparation of Inventive Resin 18

In a 1 L 3 necked flask equipped with a mechanical stirrer and water condenser, were taken imide diol 17 (38 g, 95 mmol), methacrylic acid (20.63 g, 239 mmol), PTSA mono hydrate (1.8 g, 9.5 mmol), 4-methoxyphenol (60 mg, 1000 ppm) in toluene (300 mL). The mixture was refluxed with azeotrope distillation of water for about M. After cooling to room temperature, the mixture was diluted with ethyl acetate, washed with aqueous NaHCO₃ solution twice, deionized water until the ionic conductivity was about 2 uS. The organic layer was passed through a silica column containing a short plug of sillitin in between the silica layers. Another 500 ppm pf 4-methoxyphenol was added and the solvent evaporated on rotovap to give resin 18 as a brown viscous liquid (44.1 g, 85%).

1. A resin comprising the structure: 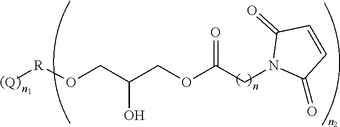
Wherein Q may be selected from: 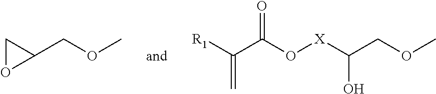
Wherein:
R is a multivalent hydrocarbyl linker selected from linear or branched alkyls, linear or branched cycloalkyls, alkylenes, cycloalkylenes, bicycloalkylenes, tricycloalkylenes, linear or branched alkylenes, linear or branched cycloalkylenes, linear or branched alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene or heterocycloarylenes; the alkyls, cycloalkyls, alkylenes, cycloalkylenes, alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene and heterocycloarylenes can optionally contain O or S or hydroxyl group;
R₁ is methyl or H;
X is CH₂, 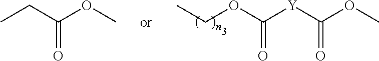
n, n₁, n₂, n₃ are each independently 1-10; and
Y is arylene, alkylene, alkenylene, aralkylene, cycloalkylene, bicycloalkylene or tricycloalkylene.

2. A resin comprising the structure: 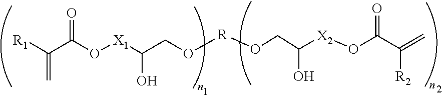
Wherein:
R is a multivalent hydrocarbyl linker selected from linear or branched alkyls, linear or branched cycloalkyls, alkylenes, cycloalkylenes, bicycloalkylenes, tricycloalkylenes, linear or branched alkylenes, linear or branched cycloalkylenes, linear or branched alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene or heterocycloarylenes; the alkyls, cycloalkyls, alkylenes, cycloalkylenes, alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene and heterocycloarylenes can optionally contain O, S or hydroxyl group;
R₁ and R₂ are independently methyl or H;
n₁ and n₂ are each independently 1-10; and
X₁ and X₂ are independently selected from CH₂, 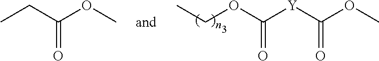
wherein n₃ is 1-10, Y is arylene, alkylene, alkenylene, aralkylene, cycloalkylene, bicycloalkylene or tricycloalkylene.

3. A resin comprising the structure: 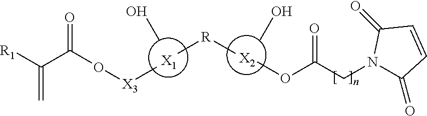
Wherein:
X₁ and X₂ are 3-10 membered ring groups independently selected from functionalized or unfunctionalized alicyclic groups optionally having one or more heteroatoms;
n is 1-10;
R is a multivalent hydrocarbyl linker selected from linear or branched alkyls, linear or branched cycloalkyls, alkylenes, cycloalkylenes, bicycloalkylenes, tricycloalkylenes, linear or branched alkylenes, linear or branched cycloalkylenes, linear or branched alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene or heterocycloarylenes; the alkyls, cycloalkyls, alkylenes, cycloalkylenes, alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene and heterocycloarylenes can optionally contain O or S or hydroxyl group; and R is linked to the ring structures containing X₁ and X₂ at any position;
X₃ is a bond linking the methacrylate group to the ring X₁, or 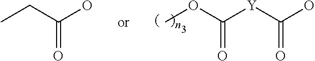
wherein n₃ is 1-10; and
Y is arylene, alkylene, alkenylene, aralkylene, cycloalkylene, bicycloalkylene or tricycloalkylene; with the proviso that hydroxyl group on X₁ ring is adjacent to the X₃ group containing (meth)acrylate, and hydroxyl group on the X₂ ring is adjacent to the maleimidoalkanoyl group, respectively.

4. A resin comprising the structure: 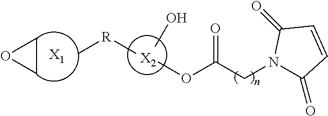
Wherein:
X₁ and X₂ are 3-10 membered ring groups independently selected from functionalized or unfunctionalized alicyclic groups optionally having one or more heteroatoms;
R is a multivalent hydrocarbyl linker selected from linear or branched alkyls, linear or branched cycloalkyls, alkylenes, cycloalkylenes, bicycloalkylenes, tricycloalkylenes, linear or branched alkylenes, linear or branched cycloalkylenes, linear or branched alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene or heterocycloarylenes; the alkyls, cycloalkyls, alkylenes, cycloalkylenes, alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene and heterocycloarylenes can optionally contain O or S or hydroxyl group;
R may be linked to the ring structures X₁ and X₂ at any position, with the proviso that the hydroxyl group on X₂ ring is adjacent to the maleimidoalkanoyl group; and
n=1-10.

5. A resin comprising the structure: 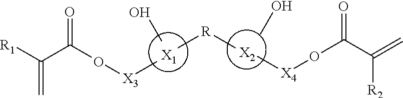
Wherein:
X₁ and X₂ are 3-10 membered ring groups independently selected from functionalized or unfunctionalized alicyclic groups optionally having one or more heteroatoms;
R is a multivalent hydrocarbyl linker selected from linear or branched alkyls, linear or branched cycloalkyls, alkylenes, cycloalkylenes, bicycloalkylenes, tricycloalkylenes, linear or branched alkylenes, linear or branched cycloalkylenes, linear or branched alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene or heterocycloarylenes; the alkyls, cycloalkyls, alkylenes, cycloalkylenes, alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene and heterocycloarylenes can optionally contain O or S or hydroxyl group; R is linked to the ring structures X₁ and X₂ at any position;
X₃ and X₄ may be independently a bond linking the (meth)acrylate groups to the rings X₁ and X₂ or 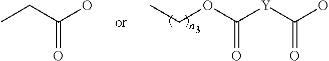
wherein n₃ is 1-10; and
Y is arylene, alkylene, alkenylene, aralkylene, cycloalkylene, bicycloalkylene or tricycloalkylene; R₁ and R₂ are independently H or methyl;
with the proviso that the hydroxyl group on X₁ ring is adjacent to X₃ group, and hydroxyl group on X₂ ring is adjacent to X₄ group.

6. A resin comprising the structure: 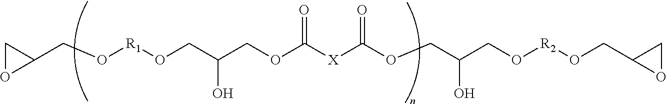
Wherein:
R₁ and R₂ are each independently multivalent hydrocarbyl linkers selected from linear or branched alkyls, linear or branched cycloalkyls, alkylenes, cycloalkylenes, bicycloalkylenes, tricycloalkylenes, linear or branched alkylenes, linear or branched cycloalkylenes, linear or branched alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene or heterocycloarylenes; the alkyls, cycloalkyls, alkylenes, cycloalkylenes, alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene and heterocycloarylenes can optionally contain O or S or hydroxyl group;
X is backbone of a dicarboxylic acid and is selected from arylenes, alkylenes, cycloalkylenes, linear or branched alkylenes, cycloalkylenes, bicycloalkylenes, tricycloalkylenes, linear or branched alkenylenes, arylenes, aralkylenes, cycloalkylarylenes, heterocycloalkylenes or heterocycloarylene; and
n is 1-10.

7. A resin comprising the structure: 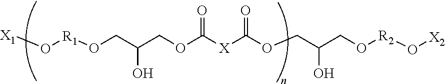
Wherein:
R₁ and R₂ are each independently multivalent hydrocarbyl linkers selected from linear or branched alkyls, linear or branched cycloalkyls, alkylenes, cycloalkylenes, bicycloalkylenes, tricycloalkylenes, linear or branched alkylenes, linear or branched cycloalkylenes, linear or branched alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene or heterocycloarylenes; the alkyls, cycloalkyls, alkylenes, cycloalkylenes, alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene and heterocycloarylenes can optionally contain O or S or hydroxyl group;
X is backbone of a dicarboxylic acid and is selected from arylenes, alkylenes, cycloalkylenes, linear or branched alkylenes, cycloalkylenes, bicycloalkylenes, tricycloalkylenes, linear or branched alkenylenes, arylenes, aralkylenes, cycloalkylarylenes, heterocycloalkylenes or heterocycloarylene;
n is 1-10;
X₁ and X₂ are polymerizable groups and are independently selected from glycidyl or (meth)acryloyl, groups, wherein X₁ and X₂ may be same when they are not glycidyl groups.

8. A resin comprising the structure: 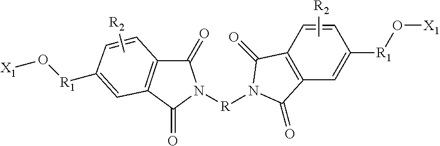
Wherein:
R is a multivalent hydrocarbyl linker selected from linear or branched alkyls, linear or branched cycloalkyls, alkylenes, cycloalkylenes, bicycloalkylenes, tricycloalkylenes, linear or branched alkylenes, linear or branched cycloalkylenes, linear or branched alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene or heterocycloarylenes; the alkyls, cycloalkyls, alkylenes, cycloalkylenes, alkenylenes, arylenes, aralkylenes, arylbicycloalkylenes, arylbicycloalkylenes, bicycloalkylarylenes, tricycloalkylarylenes, bisphenylenes, cycloalkylarylenes, heterocycloalkylene and heterocycloarylenes can optionally contain O or S or hydroxyl group;
R₁ is a linker group, which can be a carbonyl group; aliphatic or aromatic and may contain one or more of ester, ether, thioether or hydroxyl groups;
R₂ is a substituent on the aromatic ring, which can be H, halogen, alkyl, alkyl ether, thioether group; and
X₁ can be H or a polymerizable group selected from (meth)acryloyl and glycidyl groups.

9. A resin comprising the structure: 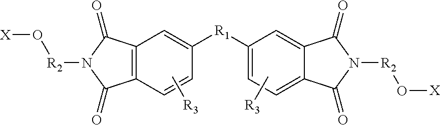
Wherein:
R₁ can be just a bond linking the two aromatic groups; O; carbonyl; or a multivalent hydrocarbyl linker selected from linear or branched alkyls, linear or branched cycloalkyls, alkylenes, cycloalkylenes, bicycloalkylenes, tricycloalkylenes, linear or branched alkylenes, linear or branched cycloalkylenes, linear or branched alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene or heterocycloarylenes; the alkyls, cycloalkyls, alkylenes, cycloalkylenes, alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene and heterocycloarylenes can optionally contain O or S or hydroxyl group;
R₂ is an aliphatic or aromatic linker which may contain one or more of ester, ether, thioether, carbonate or hydroxyl groups;
R₃ is a substituent on the aryl group, which may be H, halogen, alkyl, alkyl ether, or thio ether group; and
X is H, or a polymerizable functionality selected from a (meth)acryloyl or glycidyl group.

10. A resin comprising the structure 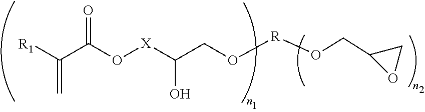
Wherein:
R is a multivalent hydrocarbyl linker selected from linear or branched alkyls, linear or branched cycloalkyls, alkylenes, cycloalkylenes, bicycloalkylenes, tricycloalkylenes, linear or branched alkylenes, linear or branched cycloalkylenes, linear or branched alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene or heterocycloarylenes; the alkyls, cycloalkyls, alkylenes, cycloalkylenes, alkenylenes, arylenes, aralkylenes, arylbicycloalkylenes, aryltricycloalkylenes, bicycloalkylarylenes, tricycloalkylarylenes, bisphenylenes, cycloalkylarylenes, heterocycloalkylene and heterocycloarylenes can optionally contain O, S or hydroxyl group;
R₁ is methyl or H;
n₁ and n₂ are each independently 1-10;
X is selected from CH₂, 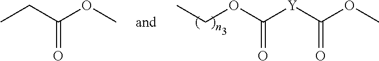
wherein n₃ is 1-10, Y is arylene, alkylene, alkenylene, aralkylene, cycloalkylene, bicycloalkylene or tricycloalkylene.

11. An ODF sealant composition comprising the resin of claim 1 and a material selected from the group consisting of free radical initiators, curing agents, fillers and combinations thereof.

12. The ODF sealant composition of claim 11 further including and a material selected from the group consisting of photoinitiators, thixotropic agents, silane coupling agents, diluents, modifiers, coloring agents, surfactants, preservatives, stabilizers, plasticizers, lubricants, defoamers, leveling agents, tougheners and combinations thereof.

13. An ODF sealant composition comprising the resin of claim 2 and a material selected from the group consisting of free radical initiators, curing agents, fillers and combinations thereof.

14. The ODF sealant composition of claim 13 further including and a material selected from the group consisting of photoinitiators, thixotropic agents, silane coupling agents, diluents, modifiers, coloring agents, surfactants, preservatives, stabilizers, plasticizers, lubricants, defoamers, leveling agents, tougheners and combinations thereof.

15. An ODF sealant composition comprising the resin of claim 3 and a material selected from the group consisting of free radical initiators, curing agents, fillers and combinations thereof.

16. The ODF sealant composition of claim 15 further including and a material selected from the group consisting of photoinitiators, thixotropic agents, silane coupling agents, diluents, modifiers, coloring agents, surfactants, preservatives, stabilizers, plasticizers, lubricants, defoamers, leveling agents, tougheners and combinations thereof.

17. An ODF sealant composition comprising the resin of claim 4 and a material selected from the group consisting of free radical initiators, curing agents, fillers and combinations thereof.

18. The ODF sealant composition of claim 17 further including and a material selected from the group consisting of photoinitiators, thixotropic agents, silane coupling agents, diluents, modifiers, coloring agents, surfactants, preservatives, stabilizers, plasticizers, lubricants, defoamers, leveling agents, tougheners and combinations thereof.

19. An ODF sealant composition comprising the resin of claim 5 and a material selected from the group consisting of free radical initiators, curing agents, fillers and combinations thereof.

20. The ODF sealant composition of claim 19 further including and a material selected from the group consisting of photoinitiators, thixotropic agents, silane coupling agents, diluents, modifiers, coloring agents, surfactants, preservatives, stabilizers, plasticizers, lubricants, defoamers, leveling agents, tougheners and combinations thereof.

21. An ODF sealant composition comprising the resin of claim 6 and a material selected from the group consisting of free radical initiators, curing agents, fillers and combinations thereof.

22. The ODF sealant composition of claim 21 further including and a material selected from the group consisting of photoinitiators, thixotropic agents, silane coupling agents, diluents, modifiers, coloring agents, surfactants, preservatives, stabilizers, plasticizers, lubricants, defoamers, leveling agents, tougheners and combinations thereof.

23. An ODF sealant composition comprising the resin of claim 7 and a material selected from the group consisting of free radical initiators, curing agents, fillers and combinations thereof.

24. The ODF sealant composition of claim 23 further including and a material selected from the group consisting of photoinitiators, thixotropic agents, silane coupling agents, diluents, modifiers, coloring agents, surfactants, preservatives, stabilizers, plasticizers, lubricants, defoamers, leveling agents, tougheners and combinations thereof.

25. An ODF sealant composition comprising the resin of claim 8 and a material selected from the group consisting of free radical initiators, curing agents, fillers and combinations thereof.

26. The ODF sealant composition of claim 25 further including and a material selected from the group consisting of photoinitiators, thixotropic agents, silane coupling agents, diluents, modifiers, coloring agents, surfactants, preservatives, stabilizers, plasticizers, lubricants, defoamers, leveling agents, tougheners and combinations thereof.

27. An ODF sealant composition comprising the resin of claim 9 and a material selected from the group consisting of free radical initiators, curing agents, fillers and combinations thereof.

28. The ODF sealant composition of claim 27 further including and a material selected from the group consisting of photoinitiators, thixotropic agents, silane coupling agents, diluents, modifiers, coloring agents, surfactants, preservatives, stabilizers, plasticizers, lubricants, defoamers, leveling agents, tougheners and combinations thereof.

29. An ODF sealant composition comprising the resin of claim 10 and a material selected from the group consisting of free radical initiators, curing agents, fillers and combinations thereof.

30. The ODF sealant composition of claim 29 further including and a material selected from the group consisting of photoinitiators, thixotropic agents, silane coupling agents, diluents, modifiers, coloring agents, surfactants, preservatives, stabilizers, plasticizers, lubricants, defoamers, leveling agents, tougheners and combinations thereof.
